(19) United States
(12) Patent Application Publication
(10) Pub. No.: US 2014/0178271 A1
(43) Pub. Date: Jun. 26, 2014

(54) Cement Clinker Production with Low Emissions

(71) Applicant: Gerardo Valdivia, Demopolis, AL (US)

(72) Inventor: Gerardo Valdivia, Demopolis, AL (US)

(21) Appl. No.: 13/725,254

(22) Filed: Dec. 21, 2012

(51) Int. Cl. B01J 19/00

(52) U.S. Cl. CPC B01J 19/0046
USPC 422/643

(57) ABSTRACT

The cement clinker production process is optimized from prior art by taking advantage of the exothermic reactions inside the sintering kiln and isolating them from the combustion process. Replacing traditional ways to burn fuels at the kiln discharge, avoiding combustion gases, dust recirculation and excess air inside the kiln by using alternative sources of heat if needed. The result of doing this is a significant decreasing in NOₓ and CO₂ emissions, less specific heat consumption, smaller main equipment for a similar capacity installation compare to prior art, among other benefits. Sending the recovered heat from the cooler thru an advantageously positioned hot air duct, it is possible to burn a good quantity of alternative fuels in the system, recovering the ashes out of the system or mixing them with the produced cement clinker.

### CROSS-REFERENCE TO RELATED APPLICATIONS

Not Applicable

### FEDERALLY SPONSORED RESEARCH

Not Applicable

### SEQUENCE LISTING

Not Applicable

### BACKGROUND

This relates to Cement Clinker production. Cement Clinker production is a high energy demand process and as a consequence high volume of gases are produced everyday by this industry. Gases are produced by combustion of fossil and non-fossil fuels, and by the necessary calcination reactions as well. Environmental constraints are forcing Cement industry to constantly look for more efficient and clean processes to produce their products. The hydraulic cements have long been recognized as an important group of cementing materials which are used principally in the construction industry. These cements have the special property of setting and hardening under water. The essential components of the cements are lime (CaO), silica (SiO₂), alumina (Al₂O₃), and the compounds derived therefrom. In the presence of water, these compounds react to form, ultimately, a hardened product containing hydrated calcium and alumina silicates. The hydraulic cements include Portland cement as well as high alumina cement, hydraulic lime, and other lesser known cements. The principal components of Portland cement are tricalcium silicate (3CaO.SiO₂) or C₃S (a special cement chemistry notation), dicalcium silicate (2CaO.SiO₂) or C₂S (a special cement chemistry notation), and tricalcium aluminate (3CaO.Al₂O₃) or C₃A (a special cement chemistry notation), all of which, when in a ground or powdered condition, will react with water to form a hard, stone-like substance held together with intermeshed crystals. Other compounds such as magnesium oxide (MgO) and tetracalcium aluminoferrite (4CaO.Al₂O₃.Fe₂O₃) or C₄AF (a special cement chemistry notation), which are present in Portland cement, do not exhibit any significant cementitious properties, The exact composition of Portland cement is defined in A.S.T.M. Standard Specifications which are accepted by the industry.

This invention relates to a process and a method for producing portland and other hydraulic cements, and more particularly to an improved process of the prior art, significantly reducing gas emissions such NOₓ and CO₂ as main benefits but not limited to.

The CO₂ emissions from Portland cement manufacturing are generated by two mechanisms. As with most high-temperature, energy-intensive industrial processes, combusting fuels to generate process energy releases substantial quantities of CO₂. Substantial quantities of CO₂ also are generated through calcining of limestone or other calcareous material. This calcining process thermally decomposes CaCO₃ to CaO and CO₂. Typically, portland cement contains the equivalent of about 63.5% CaO. Consequently, about 1.14 units of CaCO₃ are required to produce 1 unit of cement, and the amount of CO₂ released in the calcining process is about 500 kilograms (kg) per Mg of portland cement produced (1,000 pounds [lb] per ton of cement). Total CO₂ emissions from the pyroprocess depend on energy consumption and generally fall in the range of 0.85 to 1.35 Kg of CO₂ per Kg of clinker.

Several U.S. Patents explain in detail how clinker (the base of Portland cement) is produced. Most of them explain the function of the Preheater tower, Rotary kiln and clinker cooler. Any person skilled in the art of cement clinker production knows the way those devices operate. Modern processes are capable to produce good quality clinker (according to specifications) using a wide variety of fuels. Fuels are introduced to the system in two main streams (it could be more than two), The MAIN BURNER located at the discharge of the Rotary kiln and pointing inside it, and the Preheater or CALCINER burner, located up stream before the rotary kiln inlet. It is commonly accepted that the fuel split between Main burner and Preheater/Calciner burner varies depending of the installation and it can be ranged from 30% to 100% of the total fuel on the main burner and from 70% to 0% of the total fuel in the Preheater/Calciner burner. Most of the modern installations are designed to run a split of 45% on the main burner and 55% on the calciner.

During the heating up and burning process, decomposition reactions, phases transformation and formation of new phases occur. These phenomena influence each other. Regarding, the energy consumption in the kiln plant, the important aspects are the enthalpies of the reactions, which may be endothermic or exothermic. Taking advantage of the exothermic reactions necessary for clinker production, it is proposed to eliminate the use of the MAIN BURNER and provide an alternative source of heat (if needed) for the sinterization zone. Installation of an external duct (like the so-call Tertiary Air Duct) to transport recovered hot air from the clinker cooler to be used for the combustion of the fuels in the calcining apparatus, eliminating the transport of this hot air and eliminating the recirculation of dust thru the sintering kiln like in the prior art (so-called secondary air).

Another cement clinker production method using electrical energy is proposed in U.S. Pat. No. 4,477,283 where a different than the rotary kiln apparatus is described. There is no evidence that such process has been implemented at large scale for the regular production of cement clinker.

### SUMMARY

An improved cement clinker production process is proposed, taking advantage of the exothermic reactions in the kiln, isolating them from the combustion process and redirecting air and dust streams out of the kiln, reducing the specific heat consumption per ton of clinker produced and reducing the production of NOₓ and CO₂ compared to prior art. Accordingly, several other advantages are expected from this improved process and become apparent from a study of the following description and the accompanying drawings.

### BRIEF DESCRIPTION OF THE DRAWINGS

The present invention will now be illustrated, merely by way of example, with reference to the following drawings:

FIG. 1 is a schematic diagram of the preferred embodiment of the invention; showing the main involved equipment and the flow of solid materials and gases.

FIG. 2 is a schematic diagram of the second embodiment of the invention; showing the main involved equipment, the flow of solid materials, gases, and an alternative option for the transport of hot air from the clinker cooler to the preheater using an inclined rotary duct to facilitate the usage of other fuels. (i.e. Alternative fuels)

### DETAILED DESCRIPTION

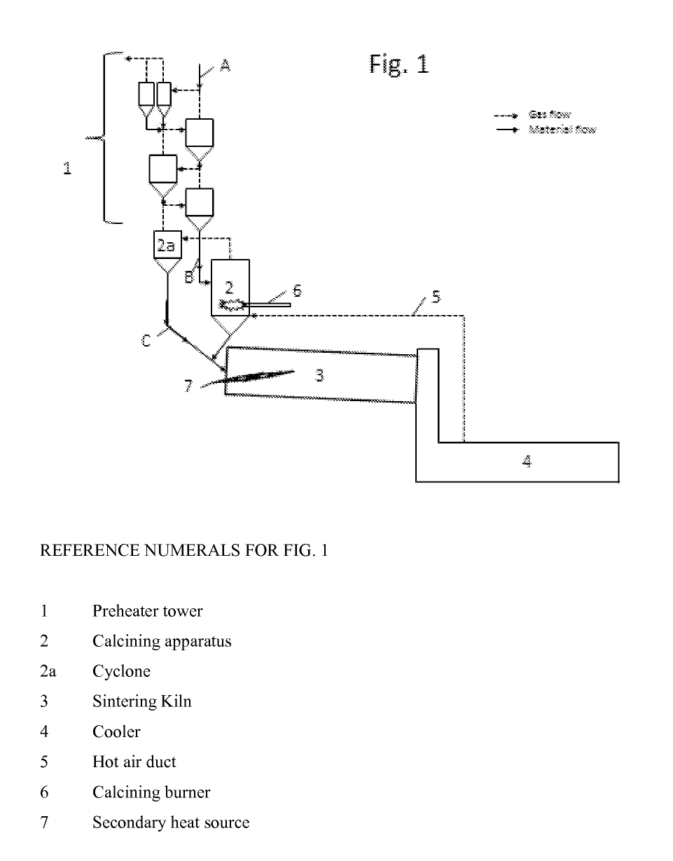

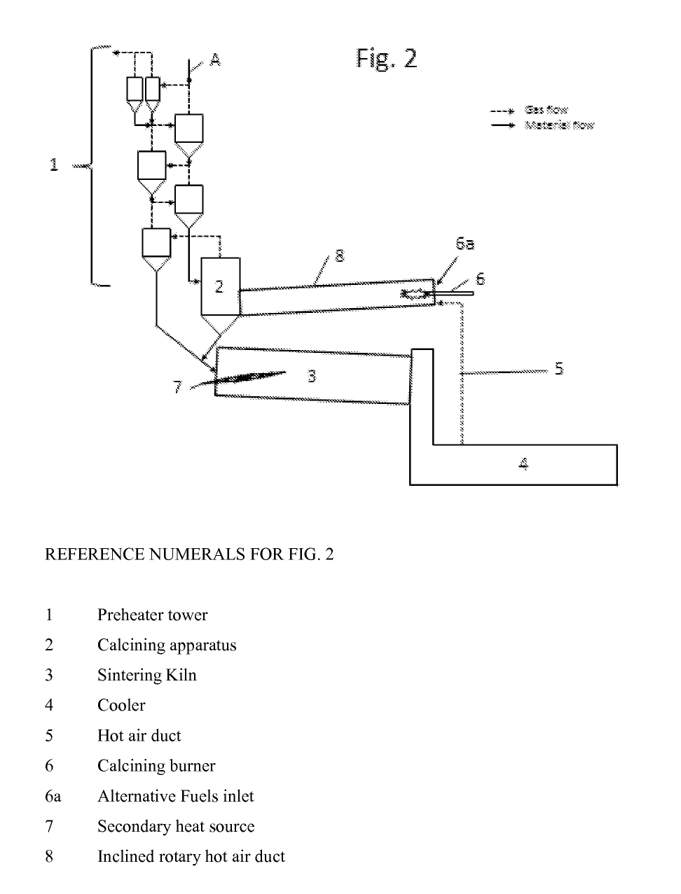

FIG. 1 shows a schematic representation of a first exemplary embodiment of a plant according to the invention, and FIG. 2 shows a schematic representation of a second exemplary embodiment of a plant according to the invention.

The plant illustrated in FIG. 1 for the production of cement clinker from cement raw material “A” essentially comprises a preheater 1 for preheating the cement raw material, a calcining apparatus 2 for precalcining the preheated cement raw material “B”, a sintering kiln 3 for completing the reactions of the precalcined cement raw material “C” to cement clinker and a cooler 4 for cooling down the hot cement clinker coming out from the kiln.

A hot air duct 5, via which hot air is supplied to the calcining apparatus, is provided between the cooler 4 and the calcining apparatus 2.

The cement raw material “A” is fed in in the upper region of the preheater 1 and passes through the preheater vessels in counter-current flow to the exhaust gases and hot air coming from the calcining apparatus 2 and hot air duct 5 flowing through the preheater.

The preheated cement raw material “B” is then supplied to the calcining apparatus 2 in order to be precalcined there while adding fuel via the burner 6 and the hot air for combustion via the duct 5.

The precalcined cement raw material “C” is separated from the exhaust and hot gases in a cyclone 2a and arrives in the sintering kiln 3 via a meal chute and kiln inlet. The sintering kiln is advantageously in the form of a rotary kiln, which is where the final cement clinker reactions take place, and as stated before, highly exothermic reactions by definition.

The hot cement clinker produced in the sintering kiln finally arrives in the cooler 4 and is cooled down there. The hot cooling air generated during cooling is fed as hot combustion air via the duct 5 to the calcining apparatus 2.

A secondary source of heat 7 is proposed in case that more temperature is needed to complete the reactions inside the sintering kiln 3. This secondary source could be electrical as described in U.S. Pat. No. 4,477,283, nuclear, microwaves, even indirect from combustion and others not mentioned here. For the experts on the art, supply this secondary source of heat could represent a challenge but, with some research it is doable and any further development costs would be offset by the advantages of reducing NOₓ, CO₂ emissions and reducing the size of the main equipment involved in the cement clinker production for a similar capacity facility in the prior art.

Within the scope of the invention it is also possible to increase the usage of alternative fuels using the exemplary embodiment showed in FIG. 2 which essentially differs of the above description adding the inclined rotary duct 8, of similar construction as the sintering kiln 3, relocating the burner 6 to the inlet of this inclined rotary hot air duct 8 and including a way to feed alternative fuels in the position 6a. The inclined rotary duct slope is advantageously inclined inverse of the sintering kiln 3 direction.

Even when certain embodiments of the present invention have been described, it should be noted that numerous possible modifications or versions of such embodiments can be made and still within the scope of the present invention in its broader aspects. The present invention, therefore, shall not be considered as limited excepting for what the prior art demands and for the spirit of the claims attached hereto.

The invention claimed is:

1. A plant for the production of cement clinker from cement raw material, having
a. A preheater for preheating the cement raw material
b. A calcining apparatus for precalcining the preheated cement raw material,
c. A sintering kiln to complete the precalcined raw material reactions to cement clinker
d. A cooler for cooling down the hot cement clinker
e. Wherein between the cooler and the calcining apparatus there is provided a hot air duct, via which hot air is supply to the calcining apparatus from the cooler
f. A rotary duct to support the burning of alternative fuels
g. A secondary source of heat to support the reactions in the sintering kiln

2. The plant according to claim 1, characterized in that the calcining apparatus has the capacity to burn 85 percent or more of the total fuel needed for the cement clinker production.

3. The plant according to claim 1, characterized in that the usage of a main burner as known by the prior art is not needed and if it is installed will burn less than 15 percent of the total fuel needed for the cement clinker production in normal operation.

4. The main burner according to claim 3, characterized that it can be used for the start up of the system.

5. The plant according to claim 1, characterized in that at least 10 percent reduction of CO₂ and NOₓ emissions is expected compared to prior art.

6. The plant according to claim 1, characterized in that specific heat consumption of at least 80 Kcal/Kg_{ck} lower than prior art is achieved.

7. The plant according to claim 1, characterized in that the use of a rotary duct to support the burning of alternative fuels could be installed or not depending of the scope of the installation.
